(19) United States
(12) Patent Application Publication
(10) Pub. No.: US 2013/0322455 A1
(43) Pub. Date: Dec. 5, 2013

(54) SWITCH SYSTEM AND METHOD FOR OPERATING A SWITCH

(71) Applicant: ACCUSYS, INC., Hsinchu County (TW)

(72) Inventor: WEN-SEN TSAI, Hsinchu County (TW)

(73) Assignee: ACCUSYS, INC., Hsinchu County (TW)

(21) Appl. No.: 13/706,202

(22) Filed: Dec. 5, 2012

(30) Foreign Application Priority Data
Jun. 4, 2012 (TW) 101120025

(51) Int. Cl. H04L 12/54

(52) U.S. Cl. CPC H04L 12/56
USPC 370/400

(57) ABSTRACT

A method for operating a switch is provided. The switch shares a resource between a plurality of thunderbolt (TB) hosts and at least a TB device, and includes a plurality of non-transparent bridges. The method includes steps of establishing a memory address mapping between each the non-transparent bridge and the TB device; providing a plurality of protocol-converting media for the plurality of TB hosts, wherein each the protocol-converting medium is converted between a first protocol and a second protocol; and causing the plurality of protocol-converting media to be converted between the first protocol and the second protocol simultaneously so as to allow the resource to be shared between the plurality of TB hosts and the TB device simultaneously.

### CROSS-REFERENCE TO RELATED APPLICATION AND CLAIM OF PRIORITY

The application claims the benefit of Taiwan Patent Application No. 101120025, filed on Jun. 4, 2012, in the Taiwan Intellectual Property Office, the disclosures of which are incorporated herein in their entirety by reference.

### FIELD OF THE INVENTION

The present invention relates to a switch and an operating method therefor, and more particularly to a switch and an operating method therefor which share the resource.

### BACKGROUND OF THE INVENTION

The peripheral component interconnect express (PCIe) protocol is a computer bus protocol, which is used to interconnect components in the computer, interconnect the device of the external chipset (e.g. the display card having a display chip), and interconnect the input/output (I/O) device of the computer for data transmission (e.g. the multimedia data) with the peripheral device. The PCIe protocol is developed by the Intel company, which has a data transmission rate of 500 MBps-8 GBps according to different bus widths and different standards. Recently, the Intel company proposes a new connector standard called “Thunderbolt (TB) protocol”, wherein each data transmission channel thereof is a duplex transmission channel, the data transmission bandwidth thereof is above 10 Gbps, and the object thereof is to be used for the universal bus between the computer and its peripheral device. The TB protocol adopts two communication protocols, which include the PCIe protocol for data transmission and the display port protocol for display. Therefore, the connector using the TB protocol can be electrically connected to different devices outside the computer simply via a wire.

Please refer to FIG. 1, which shows a conventional TB system 10 with a first electrical connection. The conventional TB system 10 includes a TB host 11 and a plurality of TB devices 12, 13, 14, 15. The TB host 11 is electrically connected to the TB devices 12, 13, 14, 15. Certainly, the TB host 11 can be electrically connected to the TB devices 12, 13, 14, 15 in a daisy-chained way, as shown in FIG. 2, which shows the conventional TB system 10 of FIG. 1 with a second electrical connection.

Through the above-mentioned two electrical connections, the TB host 11 can share the resource, e.g. the data or multimedia, with the TB devices 12, 13, 14, 15. However, currently two TB hosts cannot simultaneously share the resource among the TB devices 12, 13, 14, 15.

In order to overcome the drawbacks in the prior art, a switch system and a method for operating a switch are provided. The particular design in the present invention not only solves the problems described above, but also is easy to be implemented. Thus, the present invention has the utility for the industry.

### SUMMARY OF THE INVENTION

In accordance with an aspect of the present invention, a switch sharing the resource and a method for using the switch to share the resource are provided, which enable two or more than two TB hosts to share the resource with at least one TB device.

In accordance with another aspect of the preset invention, a method for operating a switch is provided. The switch shares a resource between a plurality of thunderbolt (TB) hosts and at least a TB device, and includes a plurality of non-transparent bridges. The method includes steps of establishing a memory address mapping between each the non-transparent bridge and the TB device; providing a plurality of protocol-converting media for the plurality of TB hosts, wherein each the protocol-converting medium is converted between a first protocol and a second protocol; and causing the plurality of protocol-converting media to be converted between the first protocol and the second protocol simultaneously so as to allow the resource to be shared between the plurality of TB hosts and the TB device simultaneously.

In accordance with a further aspect of the preset invention, a method for operating a switch is provided. The method includes steps of providing a memory address domain having a first protocol; providing a plurality of protocol-converting media for a plurality of TB hosts, wherein each the protocol-converting medium is converted between the first protocol and a second protocol; and causing the plurality of protocol-converting media to be converted with the first protocol simultaneously so as to allow the plurality of TB hosts to share a resource simultaneously.

In accordance with further another aspect of the preset invention, a method for operating a switch is provided. The switch shares a resource between a plurality of TB hosts and a plurality of TB devices. The method includes a step of causing the plurality of TB hosts to share the resource with the plurality of TB devices simultaneously.

In accordance with further another aspect of the preset invention, a switch system is provided. The switch system includes a set of TB hosts; a set of TB devices; and a switch electrically connected between the set of TB hosts and the set of TB devices, sharing a resource between the set of TB hosts and the set of TB devices, and allowing the resource to be jointly used between at least two TB hosts of the set of TB hosts and at least two TB devices of the set of TB devices.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a conventional TB system with a first electrical connection;

FIG. 2 shows the conventional TB system of FIG. 1 with a second electrical connection;

FIG. 3 shows a switch system according to an embodiment of the present invention; and

FIG. 4 is a flowchart of a method for operating a switch according to an embodiment of the present invention.

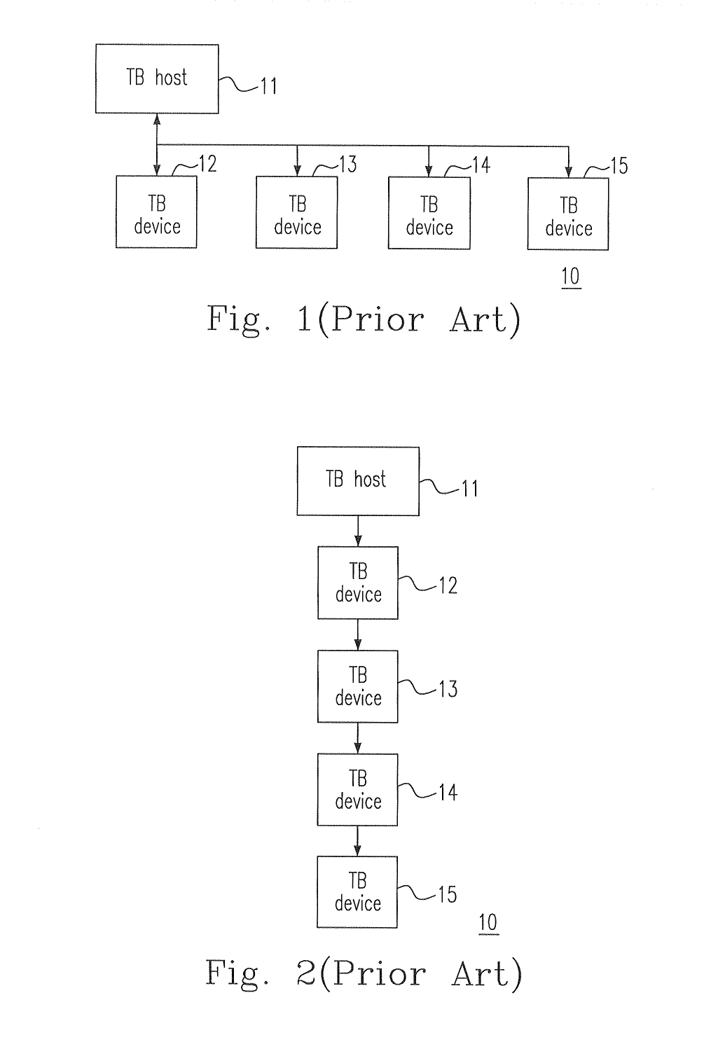

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

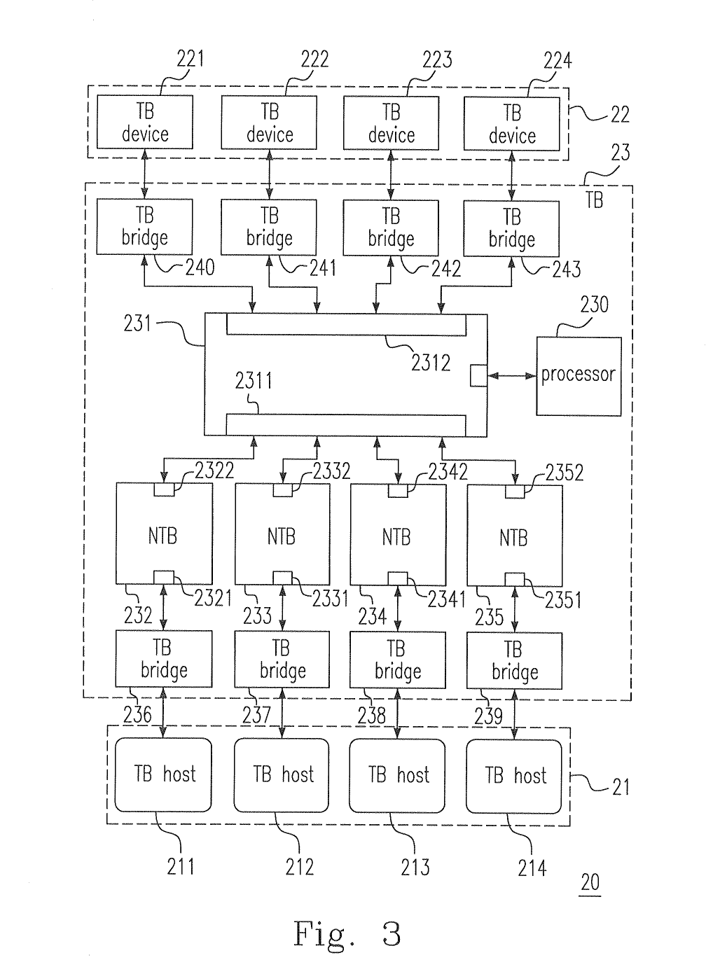

Please refer to FIG. 3, which shows a switch system 20 according to an embodiment of the present invention. The switch system 20 includes a set of TB hosts 21, a set of TB devices 22 and a TB switch 23. The TB switch 23 is electrically connected between the set of TB hosts 21 and the set of TB devices 22. The set of TB hosts 21 includes a plurality of TB hosts 211, 212, 213, 214. The set of TB devices 22 includes a plurality of TB devices 221, 222, 223, 224. The switch 23 includes a processor 230, a PCIe switch 231, a plurality of non-transparent bridges 232, 233, 234, 235 and a plurality of TB bridges 236, 237, 238, 239, 240, 241, 242, 243.

In one embodiment, each non-transparent bridge 232, 233, 234, 235 respectively has a first PCIe end-point and a second PCIe end-point. For example, the non-transparent bridge 232 has a first PCIe end-point 2321 and a second PCIe end-point 2322. The non-transparent bridge 233 has a first PCIe end-point 2331 and a second PCIe end-point 2332. The non-transparent bridge 234 has a first PCIe end-point 2341 and a second PCIe end-point 2342. The non-transparent bridge 235 has a first PCIe end-point 2351 and a second PCIe end-point 2352. The PCIe switch 231 has a first port 2311 and a second port 2312. The first port 2311 has a first PCIe memory address, and the second port 2312 has a second PCIe memory address. Each first PCIe end-point 2321, 2331, 2341, 2351 respectively has a first memory address corresponding to the memory address of each TB host 211, 212, 213, 214. Each TB host 211, 212, 213, 214 respectively has a plurality of memory address blocks corresponding to the TB devices 221, 222, 223, 224. Each second PCIe end-point 2322, 2332, 2342, 2352 respectively has a second memory address corresponding to the first PCIe memory address of the first port 2311 of the PCIe switch 231.

Firstly, how two TB hosts 211, 212 simultaneously share the resource with the TB devices 221, 222, 223, 224 is exemplified. The non-transparent bridge 232 can map the memory address of the set of TB devices 22 to the TB host 211 via the PCIe switch 231. The non-transparent bridge 233 also can map the memory address of the set of TB devices 22 to the TB host 212 via the PCIe switch 231. In this way, the TB hosts 211, 212 can share the resource with the set of TB devices 22.

In one embodiment, the memory address of the PCIe end-point 2321 is 0000h-0FFFh, which is mapped to the memory address 0000h-0FFFh of the TB host 211. The PCIe end-point 2321 has a plurality of memory positions, which respectively have the memory address 0000h-0FFFh. The TB host 211 has a plurality of positions, which respectively have the memory address 0000h-0FFFh. The memory address 0000h-0FFFh of the PCIe end-point 2321 is mapped to the memory address 0000h-0FFFh of the TB host 211, which enables the PCIe end-point 2321 to be mapped to the TB host 211. Similarly, the memory address of the PCIe end-point 2331 is 0000h-0FFFh, which is mapped to the memory address 0000h-0FFFh of the TB host 212. The function of the TB bridge 236 is to convert the PCIe protocol to the TB protocol, or to convert the TB protocol to the PCIe protocol. The TB bridge 236 is electrically connected between the TB host 211 and the non-transparent bridge 232. A memory address identical to that of the TB host 211 is configured at two end-points (not shown) of the TB bridge 236. When the data bus of the TB host 211 is 8 bits, the memory space for the TB host 211 to be mapped to the PCIe end-point 2321 is 4K bytes. The PCIe end-point 2321 also configures its memory space as 4K bytes. However, the respective memory addresses of the PCIe end-points 2322, 2332, 2342, 2352 are configured by initializing the non-transparent bridges 232, 233, 234, 235 by the processor 230 via the PCIe switch 231. For example, when performing the initialization, the respective memory addresses of the second PCIe end-points 2322, 2332, 2342, 2352 are configured as the consecutive memory addresses of 0000h-0FFFh, 1000h-1FFFh, 2000h-2FFFh and 3000h-3FFFh. The first memory address of the first port 2311 is configured as 0000h-3FFFh. The memory space of each second PCIe end-point 2322, 2332, 2342, 2352 is also 4K bytes.

In FIG. 3, the second PCIe memory address of the second port 2312 is configured as 4000h-4FFFh. The respective memory addresses of the TB devices 221, 222, 223, 224 are configured as the consecutive memory addresses of 4000h-43FFh, 4400h-47FFh, 4800h-4BFFh and 4C00h-4FFFh. In one embodiment, when the TB host 211 wants to read the data of 1K byte from the TB device 221, the processor 230 initializes the non-transparent bridge 232 and the TB device 221 via the PCIe switch 231, and maps the memory address 4000h-43FFh of the second port 2312 to the memory address 0000h-03FFh of the first port 2311. Besides, the memory address 4000h-43FFh of the second port 2312 is simultaneously mapped to the memory address of the TB device 221, and the memory address 0000h-03FFh of the first port 2311 is simultaneously mapped to the memory address of the PCIe end-point 2322. In another embodiment, when the TB hosts 211, 212 want to simultaneously read the data of 1K bytes from the TB device 221, the processor 230 initializes the non-transparent bridges 232, 233 and the TB device 221 via the PCIe switch 231, maps the memory address 4000h-43FFh of the second port 2312 to the memory address 0000h-03FFh of the first port 2311, and maps the memory address 4000h-43FFh of the second port 2312 to the memory address 1000h-13FFh of the first port 2311. Therefore, the TB hosts 211, 212 can simultaneously share the resource, e.g. the data or multimedia, from the TB device 221. However, in this way, the transmission bandwidth for the data to be transmitted to each TB host is shared. For example, the resource includes at least one of the information, data and multimedia.

In another embodiment, when the TB host 211 wants to read the data of 1K bytes respectively from each TB device in the set of TB devices 22, the processor 230 initializes the non-transparent bridge 232 and the TB devices 221, 222, 223, 224 via the PCIe switch 231, simultaneously maps the memory address 4000h-43FFh of the second port 2312 to the memory address 0000h-03FFh of the first port 2311 and the memory address 4000h-43FFh of the TB device 221, simultaneously maps the memory address 4400h-47FFh of the second port 2312 to the memory address 0400h-07FFh of the first port 2311 and the memory address 4400h-47FFh of the TB device 222, simultaneously maps the memory address 4800h-4BFFh of the second port 2312 to the memory address 0800h-0BFFh of the first port 2311 and the memory address 4800h-4BFFh of the TB device 223, and simultaneously maps the memory address 4B00h-4FFFh of the second port 2312 to the memory address 0B00h-0FFFh of the first port 2311 and the memory address 4B00h-4FFFh of the TB device 224. The memory addresses 0000h-03FFh, 0400h-07FFh, 0800h-0BFFh and 0B00h-0FFFh are simultaneously mapped to the TB host 211.

According to the PCIe protocol, the memory address of a PCIe host can be mapped to at least one PCIe device, but the respective memory addresses of two or more than two PCIe hosts cannot be mapped to at least one PCIe device. In the present invention, a plurality of non-transparent bridges 232, 233, 234, 235 each having two PCIe end-points are electrically connected to the PCIe switch 231 so that the respective memory addresses of the PCIe end-points 2322, 2332, 2342, 2352 can be integrated into a unified memory address. Therefore, with the non-transparent bridges 232, 233, 234, 235, the respective memory addresses of two or more than two PCIe hosts can be simultaneously mapped to at least one PCIe device to share the resource.

In another embodiment, the TB bridges 240, 241, 242, 243 can be omitted, and instead the PCIe switch 231 can be electrically connected to the set of TB devices 22 directly. Besides, the set of TB devices 22 can be replaced by the PCIe devices.

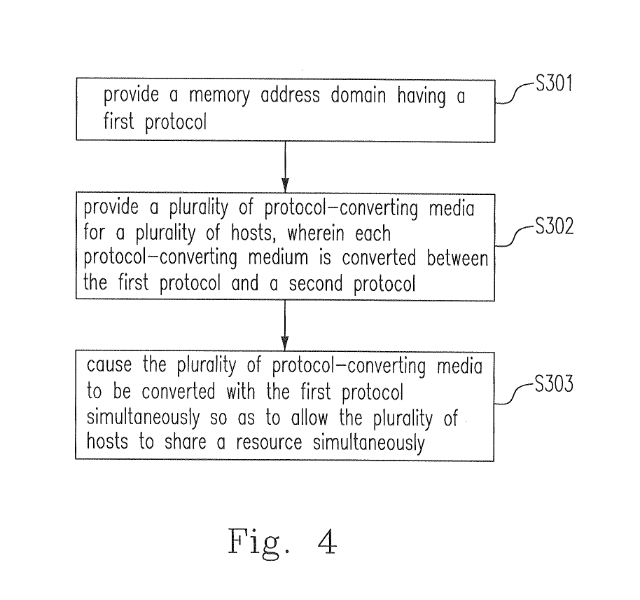

Please refer to FIG. 4, which is a flowchart of a method for operating a switch according to an embodiment of the present invention. Firstly, a memory address domain having a first protocol is provided (S301). Secondly, a plurality of protocol-converting media for a plurality of hosts are provided, wherein each protocol-converting medium is converted between the first protocol and a second protocol (S302). Thirdly, the plurality of protocol-converting media are caused to be converted with the first protocol simultaneously so as to allow the plurality of hosts to share a resource simultaneously (S303).

Please refer to FIGS. 3 and 4 simultaneously. In FIG. 3, the processor 230 initializes the non-transparent bridges 232, 233, 234, 235 and the set of devices 22, and sets a communication channel between the non-transparent bridges 232, 233, 234, 235 and the set of devices 22. The memory address of at least one TB device 221, 222, 223, 224 is sequentially mapped to the memory address domain of the PCIe switch 231. In one embodiment, after the initialization, the TB bridge 236 for the TB host 211 and the TB bridge 237 for the TB host 212 are converted between the PCIe protocol and the TB protocol. The TB bridges 236, 237 are simultaneously converted with the PCIe protocol. The non-transparent bridges 232, 233 can be simultaneously mapped to the memory address domain of the PCIe switch 231. When the TB device 221, 222, 223, 224 finishes the command of the processor 230, it sends a first interrupt signal to notify the processor 230. Then, the processor 230 sends a second interrupt signal to notify the TB host 211, 212, 213, 214 to perform a next transmission.

### EMBODIMENTS

1. A method for operating a switch, wherein the switch shares a resource between a plurality of thunderbolt (TB) hosts and at least a TB device, and includes a plurality of non-transparent bridges, comprising steps of:

establishing a memory address mapping between each the non-transparent bridge and the TB device;

providing a plurality of protocol-converting media for the plurality of TB hosts, wherein each the protocol-converting medium is converted between a first protocol and a second protocol; and

causing the plurality of protocol-converting media to be converted between the first protocol and the second protocol simultaneously so as to allow the resource to be shared between the plurality of TB hosts and the TB device simultaneously.
2. The method of Embodiment 1, wherein the switch includes a Peripheral Component Interconnect Express (PCIe) switch, the PCIe switch has a memory address domain, the memory address domain is controlled by the at least a TB device, and the non-transparent bridges includes a first non-transparent bridge and a second non-transparent bridge for communicating with the TB device.
3. The method of any one of Embodiments 1-2, further comprising steps of:

initializing the first non-transparent bridge, the second non-transparent bridge and the TB device;

causing a first memory address of the first non-transparent bridge and a second memory address of the second non-transparent bridge to be mapped to the memory address domain simultaneously; and

sharing the resource among the first non-transparent bridge, the second non-transparent bridge and the TB device.
4. The method of any one of Embodiments 1-3, wherein the switch further includes a set of transport bridges for being converted between the first protocol and the second protocol, and the transport bridges are the protocol-converting media.
5. The method of any one of Embodiments 1-4, wherein the first non-transparent bridge and the second non-transparent bridge are electrically connected to corresponding transport bridges of the set of transport bridges one-to-one.
6. The method of any one of Embodiments 1-5, wherein the first protocol is a PCIe protocol, and the second protocol is a Thunderbolt protocol.
7. The method of any one of Embodiments 1-6, wherein the plurality of TB hosts and the TB device respectively have a transmission channel having a bandwidth of above 10 Gbps.
8. The method of any one of Embodiments 1-7, wherein when the TB device finishes a transmission, it sends a first interrupt signal to notify a processor, and the processor sends a second interrupt signal to notify the TB host to perform a next transmission.
9. A method for operating a switch, comprising steps of:

providing a memory address domain having a first protocol;

providing a plurality of protocol-converting media for a plurality of TB hosts, wherein each the protocol-converting medium is converted between the first protocol and a second protocol; and

causing the plurality of protocol-converting media to be converted with the first protocol simultaneously so as to allow the plurality of TB hosts to share a resource simultaneously.
10. The method of Embodiment 9, wherein the switch includes a first non-transparent bridge and a second non-transparent bridge for communicating with a plurality of TB devices.
11. The method of any one of Embodiments 9-10, further comprising steps of:

initializing the first non-transparent bridge, the second non-transparent bridge and the plurality of TB devices;

causing a first memory address of the first non-transparent bridge and a second memory address of the second non-transparent bridge to be mapped to the memory address domain simultaneously, wherein the memory address domain is controlled by the plurality of TB devices; and

sharing the resource among the first non-transparent bridge, the second non-transparent bridge and the plurality of TB devices.
12. The method of any one of Embodiments 9-11, wherein the switch further includes a set of transport bridges for being converted between the first protocol and the second protocol, and the transport bridges are the protocol-converting media.
13. The method of any one of Embodiments 9-12, wherein the first non-transparent bridge and the second non-transparent bridge are electrically connected to corresponding transport bridges of the set of transport bridges one-to-one.
14. The method of any one of Embodiments 9-13, wherein the first protocol is a PCIe protocol, and the second protocol is a Thunderbolt protocol.
15. The method of any one of Embodiments 9-14, wherein the plurality of TB hosts and the plurality of TB devices respectively have a transmission channel having a bandwidth of above 10 Gbps.
16. The method of any one of Embodiments 9-15, wherein when the plurality of TB devices finish a transmission, they send a first interrupt signal to notify a processor, and the processor sends a second interrupt signal to notify the TB host to perform a next transmission.
17. A method for operating a switch, wherein the switch shares a resource between a plurality of TB hosts and a plurality of TB devices, comprising a step of:

causing the plurality of TB hosts to share the resource with the plurality of TB devices simultaneously.
18. The method of Embodiment 17, wherein the switch includes a first non-transparent bridge and a second non-transparent bridge, and has a memory address domain, and the method further comprises steps of:

initializing the first non-transparent bridge, the second non-transparent bridge and the plurality of TB devices;

causing the first non-transparent bridge and the second non-transparent bridge to be mapped to the memory address domain simultaneously, wherein the memory address domain is controlled by the plurality of TB devices; and

sharing the resource among the first non-transparent bridge, the second non-transparent bridge and the plurality of TB devices.
19. A switch system, comprising:

a set of TB hosts;

a set of TB devices; and
a switch electrically connected between the set of TB hosts and the set of TB devices, sharing a resource between the set of TB hosts and the set of TB devices, and allowing the resource to be jointly used between at least two TB hosts of the set of TB hosts and at least two TB devices of the set of TB devices.
20. The switch system of Embodiment 19, wherein the switch includes:

a PCIe switch having a memory address domain, wherein the memory address domain is controlled by the at least two TB devices of the set of TB devices;

a set of non-transparent bridges electrically connected to the PCIe switch; and
a processor electrically connected to the PCIe switch, initializing the set of non-transparent bridges and the set of TB devices, and causing each the non-transparent bridge to be mapped to each the TB device, wherein the PCIe switch provides a communication path between the set of non-transparent bridges and the set of TB devices to share the resource between at least two TB hosts of the set of TB hosts and the set of TB devices.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for operating a switch, wherein the switch shares a resource between a plurality of thunderbolt (TB) hosts and at least a TB device, and includes a plurality of non-transparent bridges, comprising steps of:
establishing a memory address mapping between each the non-transparent bridge and the TB device;
providing a plurality of protocol-converting media for the plurality of TB hosts, wherein each the protocol-converting medium is converted between a first protocol and a second protocol; and
causing the plurality of protocol-converting media to be converted between the first protocol and the second protocol simultaneously so as to allow the resource to be shared between the plurality of TB hosts and the TB device simultaneously.

2. A method as claimed in claim 1, wherein the switch includes a Peripheral Component Interconnect Express (PCIe) switch, the PCIe switch has a memory address domain, the memory address domain is controlled by the at least a TB device, and the non-transparent bridges includes a first non-transparent bridge and a second non-transparent bridge for communicating with the TB device.

3. A method as claimed in claim 2, further comprising steps of:
initializing the first non-transparent bridge, the second non-transparent bridge and the TB device;
causing a first memory address of the first non-transparent bridge and a second memory address of the second non-transparent bridge to be mapped to the memory address domain simultaneously; and
sharing the resource among the first non-transparent bridge, the second non-transparent bridge and the TB device.

4. A method as claimed in claim 3, wherein the switch further includes a set of transport bridges for being converted between the first protocol and the second protocol, and the transport bridges are the protocol-converting media.

5. A method as claimed in claim 4, wherein the first non-transparent bridge and the second non-transparent bridge are electrically connected to corresponding transport bridges of the set of transport bridges one-to-one.

6. A method as claimed in claim 1, wherein the first protocol is a PCIe protocol, and the second protocol is a Thunderbolt protocol.

7. A method as claimed in claim 1, wherein the plurality of TB hosts and the TB device respectively have a transmission channel having a bandwidth of above 10 Gbps.

8. A method as claimed in claim 7, wherein when the TB device finishes a transmission, it sends a first interrupt signal to notify a processor, and the processor sends a second interrupt signal to notify the TB host to perform a next transmission.

9. A method for operating a switch, comprising steps of:
providing a memory address domain having a first protocol;
providing a plurality of protocol-converting media for a plurality of TB hosts, wherein each the protocol-converting medium is converted between the first protocol and a second protocol; and
causing the plurality of protocol-converting media to be converted with the first protocol simultaneously so as to allow the plurality of TB hosts to share a resource simultaneously.

10. A method as claimed in claim 9, wherein the switch includes a first non-transparent bridge and a second non-transparent bridge for communicating with a plurality of TB devices.

11. A method as claimed in claim 10, further comprising steps of:
initializing the first non-transparent bridge, the second non-transparent bridge and the plurality of TB devices;
causing a first memory address of the first non-transparent bridge and a second memory address of the second non-transparent bridge to be mapped to the memory address domain simultaneously, wherein the memory address domain is controlled by the plurality of TB devices; and
sharing the resource among the first non-transparent bridge, the second non-transparent bridge and the plurality of TB devices.

12. A method as claimed in claim 11, wherein the switch further includes a set of transport bridges for being converted between the first protocol and the second protocol, and the transport bridges are the protocol-converting media.

13. A method as claimed in claim 12, wherein the first non-transparent bridge and the second non-transparent bridge are electrically connected to corresponding transport bridges of the set of transport bridges one-to-one.

14. A method as claimed in claim 9, wherein the first protocol is a PCIe protocol, and the second protocol is a Thunderbolt protocol.

15. A method as claimed in claim 9, wherein the plurality of TB hosts and the plurality of TB devices respectively have a transmission channel having a bandwidth of above 10 Gbps.

16. A method as claimed in claim 15, wherein when the plurality of TB devices finish a transmission, they send a first interrupt signal to notify a processor, and the processor sends a second interrupt signal to notify the TB host to perform a next transmission.

17. A method for operating a switch, wherein the switch shares a resource between a plurality of TB hosts and a plurality of TB devices, comprising a step of:
causing the plurality of TB hosts to share the resource with the plurality of TB devices simultaneously.

18. A method as claimed in claim 17, wherein the switch includes a first non-transparent bridge and a second non-transparent bridge, and has a memory address domain, and the method further comprises steps of:
initializing the first non-transparent bridge, the second non-transparent bridge and the plurality of TB devices;
causing the first non-transparent bridge and the second non-transparent bridge to be mapped to the memory address domain simultaneously, wherein the memory address domain is controlled by the plurality of TB devices; and
sharing the resource among the first non-transparent bridge, the second non-transparent bridge and the plurality of TB devices.

19. A switch system, comprising:
a set of TB hosts;
a set of TB devices; and
a switch electrically connected between the set of TB hosts and the set of TB devices, sharing a resource between the set of TB hosts and the set of TB devices, and allowing the resource to be jointly used between at least two TB hosts of the set of TB hosts and at least two TB devices of the set of TB devices.

20. A switch system as claimed in claim 19, wherein the switch includes:
a PCIe switch having a memory address domain, wherein the memory address domain is controlled by the at least two TB devices of the set of TB devices;
a set of non-transparent bridges electrically connected to the PCIe switch; and
a processor electrically connected to the PCIe switch, initializing the set of non-transparent bridges and the set of TB devices, and causing each the non-transparent bridge to be mapped to each the TB device, wherein the PCIe switch provides a communication path between the set of non-transparent bridges and the set of TB devices to share the resource between at least two TB hosts of the set of TB hosts and the set of TB devices.
